(19) United States
(12) Patent Application Publication
(10) Pub. No.: US 2008/0279285 A1
(43) Pub. Date: Nov. 13, 2008

(54) Video Processing

(75) Inventor: Richard Petrus Kleihorst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,945

(22) PCT Filed: Jun. 28, 2005
(86) PCT No.: PCT/IB2005/052135

§ 371 Date: Dec. 19, 2006

(30) Foreign Application Priority Data
Jul. 2, 2004 (EP) 04103122.0

(51) Int. Cl. H04N 7/26

(52) U.S. Cl. 375/240.26; 382/232; 375/E07.2

(57) ABSTRACT

A video processing apparatus comprises a first camera (I) for producing a first image signal (9), and a second camera (3) for producing a second image signal (11). The first image signal (9) and the second image signal (11) are offset versions of the same scene, for example relating to “right” and “left” versions of the scene as viewed through the first and second cameras, respectively. A depth estimator (5) receives the first and second image signals (9, 11), and produces a depth signal (13) for a region in the scene. A data compressor (7) receives an image signal from one of the cameras, for example the first camera (1), and compresses the video data in the image signal to produce a compressed image signal (14). The data compression for a particular region is performed based on the depth signal (13) received from the depth estimator (5) for that region. The apparatus can be configured to compress image data for objects in the foreground with a higher resolution than objects located in the background.

### FIELD OF THE INVENTION

The invention relates to a video processing apparatus and method, and in particular to a video compression apparatus and method.

### BACKGROUND OF THE INVENTION

Video compression techniques are commonly used for transmitting video signals more efficiently over communication channels having a limited bandwidth. In modern day video compression techniques, such as MPEG4, region based coding is proposed to enable different regions in the scene to be coded with different qualities. The main objective of this technique is to send important objects with high quality, while less important regions of the scene are transmitted with lower quality.

“Region based Video Coding using Mathematical Morphology”, Philippe Salembier et al, Proceedings of the IEEE, Vol. 83, No. 6, June 1995, discloses a region based coding in which regions in an image are segmented based on intensity, color and grey value. This has the disadvantage that it is not clear which is the significant object in the scene. Often, the significant object will be the moving object in the image.

### SUMMARY OF THE INVENTION

The aim of the present invention is to provide an improved video processing.

The invention is defined by the independent claims. The dependent claims define advantageous embodiments.

According to a first aspect of the present invention, there is provided a video processing apparatus for processing an image signal having one or more regions of interest. The apparatus comprises depth estimation means for determining the depth of a region in the image signal, and providing a corresponding depth signal. A data compressor receives the image signal and the depth signal, and is configured to compress the image data in a particular region based on the corresponding depth signal received from the depth estimation means.

The invention has the advantage of being able to compress a region of the image signal, for example relating to a particular object, based on the depth of that region in the image signal, and hence the importance of the region within the overall image signal.

According to another aspect of the invention, there is provided a mobile communications device comprising a first imaging means for taking a first image signal, and a second imaging means for taking a second image signal. The first and second imaging means are arranged to point in substantially the same direction.

The communications device according to this aspect of the invention has the advantage of being able to determine depth information in the image signal being viewed, which can then be used to dynamically compress different regions in the image signal as described above.

According to another aspect of the invention, there is provided a method of processing an image signal having one or more regions of interest. The method comprises the steps of determining the depth of a region in the image, signal to provide a corresponding depth signal. The depth signal is used by a data compressor for compressing the image signal, such that the image data for a particular region is compressed based on the corresponding depth of that region in the image signal.

### BRIEF DESCRIPTION OF THE DRAWINGS

For a better understanding of the invention, and to show more clearly how it may be carried into effect, reference will now be made, by way of example only, to the following drawings in which:

FIG. 1 shows a video processing apparatus according to the present invention;

FIG. 2 shows a typical scene;

FIGS. 3A and 3B show the images obtained in the first and second cameras of FIG. 1;

FIG. 4 shows a simple compression engine; and

FIG. 5 shows an alternative embodiment of the present invention.

### DETAILED DESCRIPTION OF A PREFERRED EMBODIMENT OF THE PRESENT INVENTION

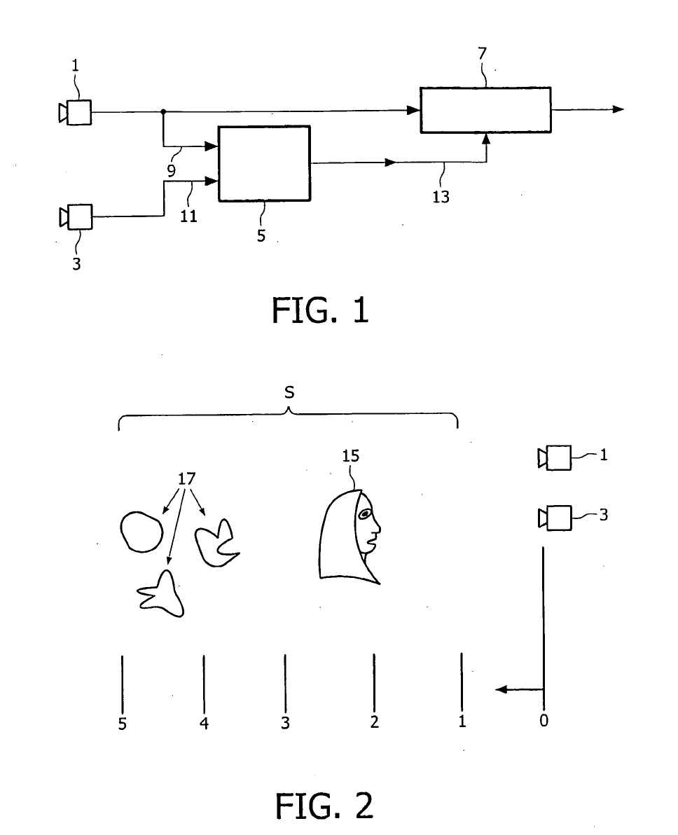

FIG. 1 discloses a video processing apparatus according to the present invention. A first camera 1 produces a first image signal 9, and a second camera 3 produces a second image signal 11. The first image signal 9 and the second image signal 11 are offset versions of the same scene, for example relating to “right” and “left” versions of the scene as viewed through the first and second cameras, respectively. A depth estimator 5 receives the first and second image signals 9, 11, and produces a depth signal 13.

A data compressor 7 receives an image signal from one of the cameras, for example the first camera 1, and compresses the video data in the image signal to produce a compressed image signal 14. The data compression level is based on the depth signal 13 received from the depth estimator 5.

For example, the apparatus can be configured to compress image data based on the assumption that the objects that are closer to the camera are more important than the objects in the background.

The depth signal 13 is determined based on the first image signal 9 and second image signal 11 received by the depth estimator 5. The first image signal 9 and the second image signal 11 are used to determine the disparity between corresponding pixels for the same object in the left and right images.

Preferably, the disparity is translated into a depth signal per pixel, which is used to control the degree of quantization in the data compressor 7 when compressing the normal image.

Thus, according to the invention, objects that are closer to the cameras are coded with high quality, i.e. high quantization, while objects that are further away from the cameras are subjected to lower coding, i.e. lower quantization resulting in a lower bandwidth requirement.

Optionally, a decision can be made to completely ignore pixels relating to the insignificant parts of the scene. In such pixels, the data compressor 7 can be configured to insert data that is more easily coded in place of the true background information. Alternatively, a flag or indicator can be inserted, which causes a receiver to insert pixel data at the receiver side.

FIG. 2 shows a typical scene S in which the main object 15 is found in the foreground, at a distance of about one to two meters away from the first and second cameras 1, 3. The less important objects 17 are found in the background of the scene, for example at a depth of about three to four meters away from the cameras 1, 3.

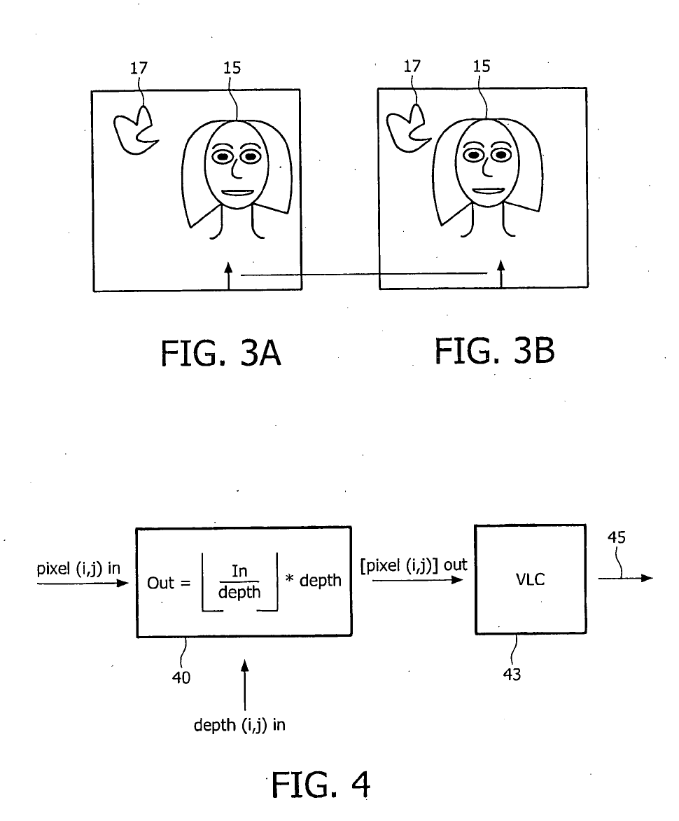

FIGS. 3A and 3B show the image signals that are seen by the first and second cameras. FIG. 3A shows the image signal seen by the second camera 3, i.e. the “left” camera in the embodiment, while FIG. 3B shows the image signal seen by the first camera 1, i.e. the “right” camera in the embodiment. As can be seen from the Figs., there is a disparity between the image signals seen by the right and left cameras. It is noted that the disparity is inversely proportional to the distance of the object to the cameras.

Disparity of a specific object in a stereoscopic image is the difference in pixels between the position of the object at the left image and the position of the same object at the right image. In other words, for a given pixel relating to a particular object, the disparity between the images seen by the first and second cameras 1, 3 will be small if the pixel relates to an object that is far away from the cameras, while the disparity will be large if the pixel relates to an object that is close to the cameras. Thus, the pixel data will appear in almost the same position in both the image frames when that pixel data relates to an object that is far away from the cameras 1, 3. Conversely, the pixel data will appear in significantly different positions in the image frame when the pixel data relates to an object that is close to the cameras 1, 3.

For example, in FIGS. 3A and 3B, the background object 17 is located in almost the same frame position in both image signals. On the other hand, there is greater disparity between the positions of the object 15, which is located in the foreground of the scene.

Various techniques for calculating the depth of an object from the images obtained from two cameras are known per se, and will not be described in greater detail in this application. These techniques include the steps of taking a specific pixel from a first image and finding the corresponding pixel in the second image. If the corresponding pixel is found, then the disparity is calculated, and a depth value assigned to that pixel.

From the above it will be seen that each pixel in the image signal is provided a depth signal, which is used to provide the quantization value for the data compressor when compressing the normal image.

FIG. 4 shows a simplified compression engine according to the present invention. The compression engine 40 receives incoming pixel data (pixel (i, j)ᵢₙ) from one of the cameras, and a depth signal (depth (i, j)ᵢₙ) from the depth estimator 5. The incoming pixel data is quantized depending upon the depth signal for that pixel, to provide an output pixel data (pixel (i, j)ₒᵤₜ). Thus, each pixel is compressed depending on the depth of the associated object from the cameras. Afterwards, known variable length coding means 43 can be used to take advantage of the compressed range of these values, to provide compressed output data 45.

The invention is particularly suited for applications in which video data must be compressed for transmission over a communication channel having a limited bandwidth. For example, the invention is particularly suited for use in a mobile telephone. According to this aspect of the invention, there is provided a mobile telephone having first and second cameras, the first and second cameras being arranged to point in substantially the same direction. The cameras can be used to determine depth information, for use in providing a depth signal for the data compression, as described above.

Alternatively, the video processing apparatus could be used to reduce the amount of video data to be stored, for example in a mobile telephone or video camera.

Although the preferred embodiment has been described in relation to the cameras providing “right” and “left” versions of the scene, it will be appreciated that any orientation will be possible, providing the two cameras are in a fixed position relative to one another. In addition, the depth value can also be measured using other means, such as “time of flight of light” from an object in a scene, or other focusing techniques for determining the depth of an object. Furthermore, when used with video cameras, the depth of an object in a scene can be determined from successive frames of the same scene, provided an object is moving between the respective frames. Although such an embodiment relies on knowledge about the size of the objects in a scene, it can nevertheless be useful for deteniniing which object is in front of the other objects, thereby enabling the closest object (and hence the most important object) to be determined.

In addition, although the preferred embodiment has been described on the basis that objects in the foreground are more important than objects in the background, it will be readily appreciated that the invention can also be used in reverse, whereby objects in the background are treated as the more important objects, for example in securing applications in which a background scene is being monitored. Alternatively, the invention could be used to provide the best quality at a predetermined depth from the cameras, for example if the cameras are used in a fixed location, and intended to monitor a scene that is at a predetermined distance away from the cameras.

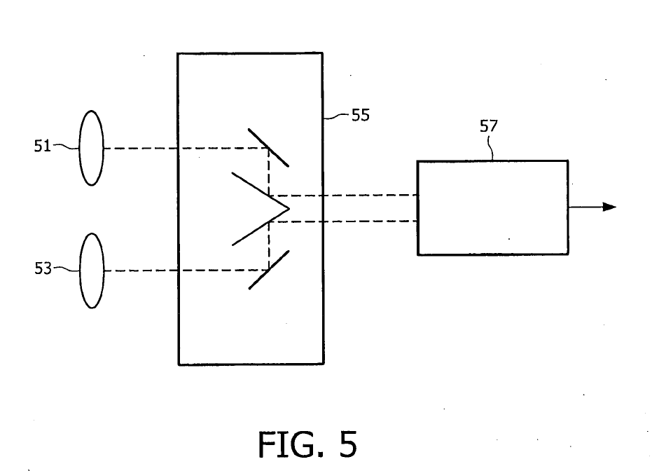

FIG. 5 shows a further embodiment for realizing the invention. Instead of having two separate cameras or sensors as shown in FIGS. 1 and 2, the embodiment of FIG. 5 has first and second lenses 51, 53. The first and second lenses are spaced apart along a direction perpendicular to the line of sight, and direct light to a periscopic mirror arrangement 55. The periscopic mirror arrangement 55 acts to direct light from the spaced apart lenses 51, 53 to a single sensor or camera 57. Thus, the left part of the image will come from the left lens, while the right part will come from the right lens. A “calibration” is performed to match the middle of the sensor to the mirrors.

The invention described in the embodiments above has the advantage of being able to compress a region of an image signal, for example relating to a particular object, based on the depth of that region in the image signal, and hence the importance of the region within the overall image signal.

It should be noted that the above-mentioned embodiments illustrate rather than limit the invention, and that those skilled in the art will be able to design many alternative embodiments without departing from the scope of the appended claims. The word ‘comprising’ does not exclude the presence of elements or steps other than those listed in a claim.

In the claims, any reference signs placed between parentheses shall not be construed as limiting the claim. The word “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A video processing apparatus for processing an image signal having one or more regions of interest, the apparatus comprising:
depth estimation means (5) for determining the depth of a region in the image signal, and providing a corresponding depth signal (13);
a data compressor (7) for receiving the image signal and the depth signal (13);
wherein the data compressor (7) is configured to compress the image data in a particular region based on the corresponding depth signal (13) received from the depth estimation means (5).

2. A video processing apparatus as claimed in claim 1, further comprising first and second cameras (1, 3), the first and second cameras (1,3) providing first and second image signals (9, 11) to the depth estimation means (5), for determining the depth of a region in the image signal.

3. A video processing apparatus as claimed in claim 2, wherein the depth estimation means (5) is configured to determine the depth of a region based on the disparity between the first and second image signals (9, 11).

4. A video processing apparatus as claimed in claim 1, wherein the data compressor is adapted to vary the quantization of the data compression (7) according to the depth signal (13).

5. A video processing apparatus as claimed in claim 4, wherein the data compressor (7) is adapted to apply high quantization to a region having a small value depth signal, and lower quantization to a region having a high value depth signal.

6. A video processing apparatus as claimed in claim 1, wherein the data compression and depth is determined on a per pixel basis.

7. A video processing apparatus as claimed in claim 6, wherein the data compressor (7) is arranged to code non-significant pixels in a predetermined mamier.

8. A video processing apparatus as claimed in claim 7, wherein the data compressor (7) is arranged to omit pixel data relating to non-significant pixels.

9. A video processing apparatus as claimed in claim 7, wherein the data compressor (7) is arranged to code pixel data for non-significant pixels with data requiring less bandwidth.

10. A video processing apparatus as claimed in claim 7, wherein the data compressor (7) is arranged to code pixel data for non-significant pixels with a flag for causing predetermined data to be inserted at a receiver.

11. A mobile communications device having video processing apparatus as defined in claim 1.

12. A mobile communications device as claimed in claim 11, further comprising:
first imaging means (1; 51) for taking a first image signal;
second imaging means (3; 53) for taking a second image signal;
wherein the first and second imaging means are arranged to point in substantially the same direction.

13. A mobile communication device as claimed in claim 12, wherein the first and second imaging means comprise first and second lenses (51, 53), respectively, the first and second lenses being spaced apart along a direction perpendicular to the line of sight.

14. A mobile communications device as claimed in claim 12, wherein the first and second imaging means comprise first and second cameras (1, 3), respectively.

15. A mobile communications device as claimed in claim 12, wherein the first and second image signals are used for determining the depth of an object in the image signal.

16. A method of processing an image signal having one or more regions of interest, the method comprising the steps of:
determining the depth of a region in the image signal to provide a corresponding depth signal;
providing a data compressor for compressing the image signal; and
compressing the data in a particular region based on the corresponding depth signal.

17. A method as claimed in claim 16, further comprising the step of providing first and second cameras (1, 3), the first and second cameras providing first and second image signals for determining the depth of a region in the image signal.
